(19) United States
(12) Patent Application Publication
(10) Pub. No.: US 2024/0317498 A1
(43) Pub. Date: Sep. 26, 2024

(54) IMPROVED METHOD FOR PICKING GOODS THAT COME FROM TWO DIFFERENT SUBSYSTEMS, AND STORAGE AND PICKING SYSTEM THEREFOR

(71) Applicant: TGW Logistics Group GmbH, Marchtrenk (AT)

(72) Inventors: Timothy LINDLEY, Schwerte (DE); Gerald KETTLGRUBER, Linz (AT)

(73) Assignee: TGW Logistics Group GmbH, Marchtrenk (AT)

(21) Appl. No.: 18/574,923

(22) PCT Filed: Jun. 28, 2022
(86) PCT No.: PCT/AT2022/060224

§ 371 Date: Dec. 28, 2023

(30) Foreign Application Priority Data
Jun. 30, 2021 (AT) A 50542/2021

(51) Int. Cl. B65G 1/137; B65G 1/04

(52) U.S. Cl. CPC B65G 1/1376; B65G 1/0457; B65G 2209/02

(57) ABSTRACT

The disclosure relates to a method for picking articles into order loading aids in a storage and picking system in which articles of a first order part and articles of a second order part are provided in different subsystems of the storage and picking system and are transported from there to a picking station. A control device defines a target article sequence in which the articles of the second order part are provided at the picking station. From that, a target order sequence is derived in which the articles of the second order part are provided at the picking station. The control device calculates a start time for the retrieval of the articles of the first order part before the articles of the second order part are sorted according to the target article sequence. A storage and picking system for the performance of the method is provided.

The invention concerns a method for picking articles into order loading aids in a storage and picking system. Furthermore, the invention concerns a storage and picking system for the performance of the method having a first subsystem, a second subsystem, a first transport system, a second transport system, a first picking station, a second picking station, a temporary storage, a sorting device, an order-processing computer, and a control device.

Such a method and such a storage and picking system are fundamentally known in the prior art. For example, U.S. Pat. No. 10,427,873 B1 discloses a picking system and a picking method in which a packing pattern is generated for an order that defines a packing sequence. Moreover, a distinction is made between articles that can be transported in a bag and articles that cannot be transported in a bag. The former are retrieved from storage and packaged into a bag at a picking station. The articles in the bags and the articles that cannot be transported in a bag are transported synchronously to a merging and packaging station. The two types of articles are reloaded into a shipping unit there.

The disadvantage of the known picking system and picking method is that an unfortunate selection of a time at which the transportation of the articles to the merging and packaging station is initiated along with difficult to estimate or unpredictable occurrences on the transport route can lead to a desynchronisation of the article flows. That leads to an excessively long occupation of the merging and packaging station and thus unavoidably also to blockages on the upstream conveyor path.

In particular, this affects storage and picking systems in which articles are sourced from several subsystems that can only be operated in alignment with each other with difficulty, such as subsystems from different manufacturers. Furthermore, storage and picking systems are affected in which the latency of a request to provide an article until the actual receipt of the article at a picking station is difficult to predetermine. In particular, this affects storage and picking systems in which articles have to partially first be produced to order.

One object of the invention is thus to provide an improved method for picking articles into order loading aids and an improved storage and picking system. In particular, a desynchronisation of article flows at a picking station, even under difficult conditions, shall be avoided.

The object of the invention is solved by a method for picking articles into order loading aids in a storage and picking system comprising the following steps:
a) acquisition of a plurality of orders and determination of the articles comprised by the respective order by an order-processing computer of the storage and picking system;
b) determination by the order-processing computer of a first order part having a first part of the articles comprised by the respective order which are provided in a first subsystem of the storage and picking system for each order of the acquired orders;
c) determination by the order-processing computer of a second order part having a second part of the articles comprised by the respective order which are provided in a second subsystem of the storage and picking system for each order of the acquired orders;
d) (provision of articles of the respective first order part and of an order loading aid assigned to the respective order at a first picking station) loading of an order loading aid assigned to the respective order with the articles of the first order part of the orders at a first picking station of the storage and picking station;
e) transportation of the order loading aid from the first picking station to an intermediate storage of the storage and picking station by means of a first transport system of the storage and picking station;
f) buffering of the order loading aid in the temporary storage;
g) retrieval of the order loading aid from the temporary storage and delivery of the order loading aid to a second picking station of the storage and picking station;
h) definition of a target article sequence in which the articles of the second order parts of the orders are provided at the second picking station by a (electronic) control device, wherein the target article sequence specifies a target order sequence in which the orders at the second picking station are processed;
i) delivery of the articles of the second order parts of the orders to a sorting device of the storage and picking station by means of the second transport system;
j) sorting of the articles of the second order parts of the orders in the sorting device according to the target article sequence;
k) retrieval of the articles of the second order parts from the sorting device and delivery of the articles of the second order parts of the orders to the second picking station according to the target article sequence by means of the second transport system;
l) loading of the articles of the respective second order part of the orders onto the order loading aid assigned to the respective order at the second picking station;
   wherein the control device controls the first transport system and the first transport system transports the order loading aid according to the specified target order sequence in order to perform the delivery according to step g), and
   wherein the control device calculates a starting time for the retrieval according to step g) before the articles of the second order parts of the orders are sorted according to the target article sequence, and controls the transport system to initiate the retrieval according to step g).

Furthermore, the object of the invention is solved by a storage and picking system for picking articles into order loading aids, comprising
a first subsystem in which articles can be provided;
a second subsystem in which articles can be provided;
an order-processing computer
i) for the acquisition of a plurality of orders and determination of the articles comprised by the respective order,
ii) for the determination of a first order part having a first part of the articles comprised by the respective order which are provided in the first subsystem of the storage and picking system for each order of the acquired orders;
iii) for the determination of a second order part having a second part of the articles comprised by the respective order which are provided in the second subsystem for each order of the acquired orders;
a first picking station for the loading of an order loading aid assigned to the respective order with the articles of the first order part of the orders;
a second picking station for the loading of the order loading aid assigned to the respective order with the articles of the second order part of the orders;
a temporary storage for the buffering (temporary storing) of the order loading aids;
a first transport system for the transportation of the order loading aid from the first picking station to the temporary storage and for the retrieval of the order loading aid from the temporary storage and delivery of the order loading aid to a second picking station;
a (electronic) control device for the definition of a target article sequence in which the articles of the second order parts of the orders are provided at the second picking station of the storage and picking system, wherein the target article sequence specifies a target order sequence in which the orders at the second picking station are processed;
a sorting device for sorting the articles of the second order parts of the orders according to the target article sequence;
a second transport system for delivering the articles of the second order parts of the orders to the sorting device and for retrieving the articles of the second order parts from the sorting device and delivering the articles of the second order parts of the order to the second picking station according to the target article sequence,
   wherein
   the control device is further configured to
control the first transport system for transporting the order loading aids according to the specified target order sequence, and
calculate a starting time for the retrieval of the order loading aids from the temporary storage before the articles of the second order parts of the orders are sorted according to the target article sequence, and to control the first transport system to initiate the retrieval of the order loading aids from the temporary storage at the start time.

The proposed measures allow for a desynchronisation of article flows at a picking station to be avoided, even under difficult conditions. The proposed measures are therefore particularly suited for storage and picking systems in which articles are sourced from several subsystems that can only be operated in alignment with each other with difficulty, such as subsystems from different manufacturers. Furthermore, the proposed measures are particularly suitable for storage and picking systems in which the latency of a request to provide an article until the actual receipt of the article at a picking station is difficult to predetermine.

The control device is configured to calculate a start time and trigger the first transport system in such a way that the retrieval is initiated or started at the start time. To do so, the control device can trigger the transport system temporally prior to the start time, whereby the retrieval begins at the start time. Alternatively, the control device can trigger the transport system at the start time to immediately start the retrieval.

Preferably, the control device calculates the start time so that the order loading aids are provided by the first transport system and the articles are provided by the second transport system substantially simultaneously (synchronously) at the second picking station. A transport time needed to transport the order loading aids from the temporary storage to the second picking station can hereby be taken into account by the control device. Furthermore, a transport time needed to transport the articles of the second order part to the second picking station can hereby be taken into account by the control device. The respective transport times can also be calculated by the control device.

In particular, the first subsystem of the storage and picking system can be formed by or comprise an article storage, wherein the articles of the first order part are provided in this article storage and are or can be retrieved from this article storage to order. The first subsystem is therefore particularly suited for providing articles per se ready for shipment (i.e. articles which require no further processing).

In particular, the second subsystem of the storage and picking system can be formed by or comprise a production, wherein the articles of the second order part are produced in this production to order. In this regard, that means the production is equipped to produce the articles of the second order part to order. In particular, it can be equipped for the production of books, shoes, or clothing articles. Generally, the production can also address the customisation of pre-fabricated articles (value-added service). For instance, clothing articles or shoes can be printed or embroidered. It is also conceivable that books can be printed and bound to order.

Advantageously, the order loading aids are configured differently to the hanging bags. In particular, the order loading aids can be configured as containers, boxes, shipping packages (shipping boxes, shipping envelopes) etc. Accordingly, in this case the first transport system comprises a conveying system distinct from an overhead conveyor system. This conveying system can, for example, by configured as a stationary (ground-based) conveying system, in particular a roller conveyor system or belt conveyor system. Alternatively, the first conveying system can be configured as a mobile conveying system, comprising, for example, “automated guided vehicles” (AGV) or “autonomous mobile robots” (AMR).

The second transport system preferably comprises an overhead conveyor system for the suspended transportation of hanging bags in which the articles of the second order part are transported. Preferably, each hanging bag transports one article of the second order part. If multiple articles are transported simultaneously by one transport carrier or one hanging bag, they are predominantly articles of the same article type. In particular, a hanging bag can be configured according to patent application WO 2019/195871 A1 or WO 2020/150762 A1 and can be used in the manner described therein for the method and the storage and picking system disclosed herein. Although the transportation of the articles of the second order part in hanging bags is advantageous, the use of other loading aids for the articles of the second order part is nevertheless also conceivable.

The order loading aid can be loaded at the first picking station with articles provided there.

For example, the first picking station can be configured as an automatic picking station, in particular comprising a picking robot.

Alternatively, the first picking station can be configured as a manual picking station. The manual picking station can comprise a storage and/or retrieval device. Preferably, the storage and/or retrieval device has a display means for issuing picking instructions, such as a monitor where the operating personnel receive picking instructions. Furthermore, the storage and/or retrieval device can have an input means for entering a confirmation command, for example a keyboard or a button by means of which the operating personnel can confirm the completed picking operation. The display means and input means can be provided as a touch display, for instance.

The order loading aid can be loaded at the second picking station with articles provided there by the second transport system.

If the articles are provided at the second picking station in hanging bags, for example, the loading of the order loading aid can comprise a reloading of the articles from the hanging bag into the order loading aid.

For example, the second picking station can be configured as an automatic picking station, in particular comprising a picking robot.

Alternatively, the second picking station is configured as a manual picking station. The manual picking station can comprise a storage and/or retrieval device. Preferably, the storage and/or retrieval device has a display means for issuing picking instructions, such as a monitor where the operating personnel receive picking instructions. The picking instructions can hereby comprise an instruction to retrieve an article from a hanging bag and/or deposit the article in the order loading aid if the article is provided at the second picking station in a hanging bag. Furthermore, the storage and/or retrieval device can have an input means for entering a confirmation command, for example a keyboard or a button by means of which the operating personnel can confirm the completed picking operation. The display means and input means can be provided as a touch display, for instance.

The temporary storage comprises buffer bays where the order loading aids can be stored temporarily.

If the second transport system comprises an overhead conveyor system, the sorting device can advantageously be configured as a matrix sorter.

Further advantageous embodiments and further embodiment variations of the invention can be derived from the dependent claims and from the description in conjunction with the figures.

It is beneficial if the second order part is assigned to one of a plurality of second picking stations and this assignment is used as a specification for the first order part. That ensures the synchronisation of the delivery of the order loading aids and the articles of the second order parts even if there are multiple second picking stations. Said assignment can be performed
randomly,
on the basis of a shipping loading aid already provided at the second picking station into which the articles comprised by the respective order are to be reloaded (with or without a second order loading aid),
on the basis of order prioritisation, wherein several collated orders are processed in a certain sequence or at certain times at the second picking station (step 1),
on the basis of a construction of the second picking stations, wherein in particular the second picking station which is most suited for performing step 1) is selected,
and/or
on the basis of a workload of the second picking stations, wherein the articles of the first order parts and the articles of the second order parts of multiple orders are preferably distributed evenly across the available second picking stations.

If allocation is performed according to workload, it can thereby be ensured that individual warehouse workers (picking staff) at the second picking stations are not overworked and are not subjected to a one-sided strain by distributing the first and second order parts.

Random assignment over a sufficiently long time period also achieves even workloads on the second picking stations, however without the adherence thereto having to be measured or monitored.

It would also be conceivable for a shipping loading aid to be loaded with articles from multiple orders, either with or without order loading aids. For example, a palette (shipping loading aid) can be loaded with order loading aids from multiple orders which are consequently shipped together.

In the case of assignment based on the construction of the second picking stations, it can, for example, be taken into account whether one picking robot is better suited for picking the articles of the second order part at a certain second picking station than another picking robot at another second picking station.

In the case of assignment based on order prioritisation, certain second picking stations can be kept free or run at low capacity for urgent orders. If such an urgent order is received, the articles of that order can be processed or picked at such a second picking station.

Furthermore, it is advantageous if an order to provide the articles of the second order part is issued once step d) is completed, i.e. once the loading of the order loading aid with the articles of the first order part at the first picking station is completed. It can thereby be ensured that the articles of the first order part are definitely available when the articles of the second order part are provided, in particular produced. Overloading of the sorting device can thereby be very reliably avoided because transporting away the articles of the second order cannot be delayed due to the articles of the first order part or the order loading aid not being available.

It is beneficial if after being retrieved from storage or production, the articles of the second order part are transported into a pre-sorting stage of the sorting device and pre-sorted there and subsequently transported to a final sorting stage of the sorting device and sorted there before being transported to the second picking station. The final sorting stage is thereby configured in particular as a matrix sorting device. The proposed measures achieve a particularly efficient sorting of the articles of the second order part. Two-stage sorting is, however, not essential. Rather, after retrieval from storage or production, in particular by bypassing the pre-sorting stage, the articles can be transported directly to the final sorting stage or directly to the matrix sorting device and sorted there.

It is particularly advantageous if a transportation of the order loading aid with the articles of the first order part to the second picking station is triggered when step d) is completed (i.e. when the loading of the order loading aid with the articles of the first order part at the first picking station is completed) and the articles of the second order part are available in the pre-sorting stage or alternatively in the final sorting stage. That very reliably ensures the synchronisation of the delivery of the order loading aids and the articles of the second order parts.

Finally, it is advantageous if after retrieval from storage or production, the articles of the second order part are transported to a buffer of the storage and picking system arranged between the second subsystem and the pre-sorting stage. The buffer serves to balance out fluctuations in the article flow on the second transport system. That also achieves an improved, even workload on the sorting device.

For a better understanding of the invention, it is explained in more detail with reference to the following FIGURE. It shows:

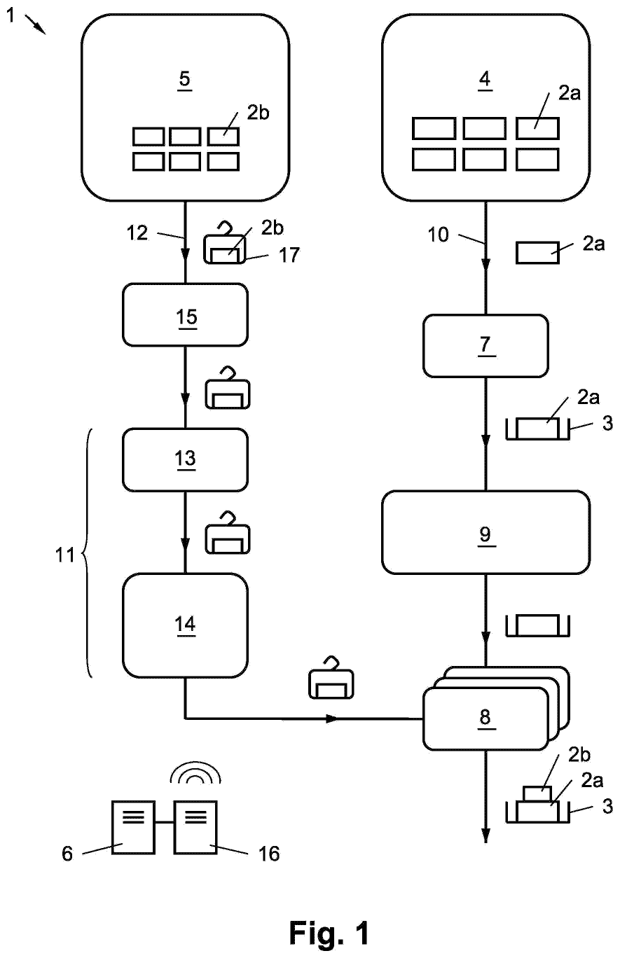

FIG. 1 an example storage and picking system for picking articles in significantly simplified, schematic representation.

FIG. 1 shows an example schematic representation of the storage and picking system 1 for picking articles 2a, 2b in order loading aids 3. The storage and picking system 1 comprises a first subsystem 4 in which articles 2a can be provided, and a second subsystem 5 in which articles 2b can also be provided.

Furthermore, the storage and picking system 1 comprises an order-processing computer 6 which is configured inter alia to acquire a plurality of orders and determine the articles 2a, 2b comprised by the respective order.

In addition, the storage and picking system 1 has a first picking station 7 for loading an order loading aid 3 with articles 2a and a second picking station 8 for loading the order loading aid 3 with articles 2b, and a temporary storage 9 for buffering the order loading aids 3. The storage and picking system further comprises a first transport system for the transportation of the order loading aid from the first picking station to the temporary storage and for the retrieval of the order loading aid from the temporary storage and delivery of the order loading aid to a second picking station. In this example, the first transport system 10 is also configured to transport the articles 2a to the first picking station 7.

Furthermore, the storage and picking system 1 has a sorting device 11 for sorting the articles 2b, and a second transport system 12 for transporting the articles 2b to the sorting device 11 and for transporting the articles 2b away from the sorting device 11 and transporting the articles 2b to the second picking station 8. In this example, the sorting device 11 comprises a pre-sorting stage 13 and a subsequent final sorting stage 14 which is configured in particular as a matrix sorting device. It would also be conceivable that the sorting device 11 is constructed differently and that the pre-sorting stage is omitted, for example. An optional buffer 15 is additionally positioned before the pre-sorting stage.

Finally, the storage and picking system 1 comprises a control device 16 which is intended, inter alia, for the definition of a target article sequence in which the articles 2b are provided at the second picking station 8.

As can be seen in FIG. 1, the first transport system 10 connects the first subsystem 4, the first picking station 7, the temporary storage 9, and the second picking station 8. The second transport system 12 connects the second subsystem 5, the buffer 15, the pre-sorting stage 13, the final sorting stage 14, and the second picking station 8. A non-designated conveying system also leads away from the second picking station 8.

In this example, the first subsystem 4 of the storage and picking system 1 is formed by or comprises an article storage for the provision of the articles 2a of a first order part. Provided articles 2a can be retrieved from this article storage to order.

In this example, the second subsystem 5 of the storage and picking system 1 is advantageously formed by or comprises a production. The production is equipped to be able to produce or finish articles 2b of the second order part to order. In particular, the production can be equipped for the production or customisation of books, shoes, or clothing articles.

In this example, the second transport system 12 comprises an overhead conveyor system for the suspended transportation of hanging bags 17 in which articles 2b of a second order part are transported. Preferably, each hanging bag 17 transports one article 2b of the second order part. It is also conceivable that the article 2b is transported on a clothes hook (and thus without a hanging bag 17), wherein in this case preferably exactly one article 2b is transported by one clothes hook. If multiple articles 2b are transported simultaneously by one transport carrier or one hanging bag 17, they are predominantly articles 2b of the same article type. In particular, a hanging bag 17 can be configured according to patent application WO 2019/195871 A1 or WO 2020/150762 A1 and can be used in the manner described therein for the method and the storage and picking system 1 disclosed herein. Although the transportation of the articles 2b of the second order part in hanging bags is advantageous, the use of other loading aids for the articles of the second order part is nevertheless also conceivable.

In this example, the order loading aids 3 are configured differently to a hanging bag 17. In particular, the order loading aids 3 can be configured as containers, boxes, shipping packages (shipping boxes, shipping envelopes) etc. . . . Accordingly, the first transport system 10 in this example also comprises a conveying system distinct from an overhead conveyor system. In particular, the first transport system 10 can be configured as a container conveyor system, for instance as a ground-based conveying system for the horizontal transport of articles 2a. In specific terms, the first transport system 10 can thus have roller conveyors or belt conveyors.

The storage and picking system 1 shown in FIG. 1 functions as follows:

A method for picking articles 2a, 2b in an order loading aid 3 in the storage and picking system 1 comprises the following steps:
a) acquisition of a plurality of orders and determination of the articles 2a, 2b comprised by the respective order by the order-processing computer 6;
b) determination by the order-processing computer 6 of a first order part having a first part of the articles 2a comprised by the respective order which are provided in the first subsystem 4 for each order of the acquired orders;
c) determination by the order-processing computer 6 of a second order part having a second part of the articles 2b comprised by the respective order which are provided in the second subsystem 5 for each order of the acquired orders;
d) loading of an order loading aid 3 assigned to the respective order with the articles 2a of the first order part of the orders at the first picking station 7;
e) transportation of the order loading aid 3 from the first picking station 7 to the temporary storage 9 by means of the first transport system 10;
f) buffering of the order loading aid 3 in the temporary storage 9;
g) retrieval of the order loading aid 3 from the temporary storage 9 and delivery of the order loading aid 3 to a second picking station 8 by means of the first transport system 10;
h) definition of a target article sequence by a control device 16 in which the articles 2b of the second order parts of the orders are provided at the second picking station 8, wherein the target article sequence specifies a target order sequence in which the orders at the second picking station 8 are processed;
i) delivery of the articles 2b of the second order parts of the orders to the sorting device 11 by means of the second transport system 12;
j) sorting of the articles 2b of the second order parts of the orders in the sorting device 11 according to the target article sequence;
k) retrieval of the articles 2b of the second order parts from the sorting device 11 and delivery of the articles 2b of the second order parts of the orders to the second picking station 8 according to the target article sequence by means of the second transport system 12 and
l) loading of the articles 2b of the respective second order part of the orders onto the order loading aid 3 assigned to the respective order at the second picking station 8.

Triggered by the control device 16, the first transport system 10 thereby transports the order loading aids 3 according to the specified target order sequence to perform delivery according to step g).

Furthermore, the control device 16 thereby calculates a start time for the transportation away according to step g) before the articles 2b of the second order parts of the orders are sorted according to the target article sequence, and triggers the first transport system 10 to initiate the transportation away according to step g) at the start time.

If an order is received in the storage and picking system 1, it is thus determined which articles 2a are provided in the first subsystem 4 (article storage) and which articles 2b are provided in the second subsystem 5 (production). The articles 2a are then transported from the first subsystem 4 to the temporary storage 9 and temporarily stored there.

Likewise, the articles 2b are conveyed from the second subsystem to the buffer 15. The buffer 15 serves to balance out fluctuations in the article flow on the second transport system 12 and does not necessarily have to be provided. From there, the articles 2b move into the pre-sorting stage 13 and subsequently into the final sorting stage 14. The articles 2b are sorted in the sorting device 11 according to a target article sequence which is defined by the control device 16.

The target article sequence specifies in which order the articles 2b are provided at the second picking station 8. The target article sequence also specifies a target order sequence according to which orders are processed at the second picking station 8.

The order loading aids 3 are loaded with the articles 2b of the respective second order part at the second picking station 8. For this purpose, the order loading aid 3 first has to be transported from the temporary storage 9.

To synchronise the arrival of the order loading aids 3 and the articles 2b of the second order parts at the second picking station 8, a start time for the retrieval of the order loading aids 3 from the temporary storage 9 is calculated by the control device 16. The control device 15 further triggers the first transport system 10 to initiate said retrieval at the start time. The calculation of said start time thereby occurs before the articles 2b of the second order parts are sorted according to the target article sequence. Using the proposed measures, it is ensured that the order loading aids 3 arrive at the second picking station 8 at a desired time and in a desired order.

By synchronising and predictively calculating a start time and a target order sequence, irregularities in the picking method operation, in particular article jams on the first subsystem 4 and on the second subsystem 5 as well as overloads of the temporary storage 9, the buffer 15, the pre-sorting stage 13 and the final sorting stage 14 (i.e. the sorting device 11) are avoided. Advantageously, in particular uncertainties in time planning for the production of the articles 2b are thereby considered. Thus, article jams and overloads are avoided even though the time for the provision of the articles 2b of the second order parts is not exactly pre-determinable (in contrast to the relatively precisely known time requirement for the provision of the articles 2a of the first order parts).

It is advantageous if an order to provide the articles 2b of the second order part is issued once step d) is completed, i.e. once the loading of the order loading aid 3 with the articles 2a of the first order part at the first picking station 7 is completed. It can thereby be ensured that the articles 2a of the first order part are definitely available when the articles 2b of the second order part are provided, in particular produced. Overloading of the sorting device 11 can thereby very reliably be avoided because transporting away the articles 2b of the second order cannot be delayed due to the articles 2a of the first order part or the order loading aid 3 not being available.

It is particularly advantageous if a transportation of the order loading aid 3 with the articles 2a of the first order part to the second picking station 8 is triggered when step d) is completed (i.e. when the loading of the order loading aid 3 with the articles 2a of the first order part at the first picking station 7 is completed) and the articles 2b of the second order part are available in the pre-sorting stage 13 or alternatively in the final sorting stage 14. That very reliably ensures the synchronisation of the delivery of the order loading aids 3 and the articles 2b of the second order parts.

In one embodiment variation of the described method, the second order part is assigned to one second picking station 8 of a plurality of second picking stations 8, wherein this assignment is used as a specification for the first order part. That ensures the synchronisation of the delivery of the order loading aids 3 and the articles 2b of the second order parts even if there are multiple second picking stations 8.

In the following, a number of additional examples of a target article sequence and a target order sequence are given. In particular if several orders each have several articles 2b of second order parts, the target order sequence and the target article sequence can deviate from one another. One example has orders 1, 2 and 3, which involve articles 2b of the article types A, B, C and D.

| Order | Article type |
|---|---|
| 1 | A |
| 1 | B |
| 1 | C |
| 2 | A |
| 2 | B |
| 2 | C |
| 3 | D |
| 3 | C |

An example of a target article sequence and target order sequence pair can thus be: Target article sequence=ABC ABC DC Target order sequence=123. For the same target article sequence=ABC ABC DC, the target order sequence=213 would also be possible, whereas the target article sequence=DC ABC ABC would lead to the target order sequence=312 or 321.

Finally, it should be noted that the scope of protection is defined by the claims. The description and the drawings should, however, be consulted when construing the claims. Individual features or combinations of features from the various example embodiments as shown and described can constitute separate inventive solutions. The problem to be solved by the individual inventive solutions can be derived from the description.

In particular, it should be noted that in reality the represented devices can comprise more or fewer components than shown. The represented devices and their components can partially also be shown not to scale and/or in magnification and/or shrunk down.

### LIST OF REFERENCE NUMERALS

1 Storage and picking system
2a, 2b Article
3 Order loading aid
4 First subsystem (article storage)
5 Second subsystem (production)
6 Order-processing computer
7 First picking station
8 Second picking station
9 Temporary storage
10 First transport system (container conveyor system)
11 Sorting device
12 Second transport system (overhead conveyor system)
13 Pre-sorting stage
14 Final sorting stage (matrix sorting device)
15 Buffer
16 Control device
17 Hanging bag

1. A method for picking articles into an order loading aid in a storage and picking system, comprising the following steps:
a) acquisition of a plurality of orders and determination of the articles comprised by the respective order by an order-processing computer;
b) determination by the order-processing computer of a first order part having a first part of the articles comprised by the respective order which are provided in a first subsystem for each order of the acquired orders;
c) determination by the order-processing computer of a second order part having a second part of the articles comprised by the respective order which are provided in a second subsystem for each order of the acquired orders;
d) loading of an order loading aid assigned to the respective order with the articles of the first order part of the orders on a first picking station;
e) transportation of the order loading aid from the first picking station to a temporary storage by means of a first transport system;
f) buffering of the order loading aid in the temporary storage;
g) retrieval of the order loading aid from the temporary storage and delivery of the order loading aid to a second picking station by the first transport system;
wherein:
h) a control device defines a target article sequence in which the articles of the second order parts of the orders are provided at the second picking station, wherein the target article sequence specifies a target order sequence in which the orders at the second picking station are processed;
i) the articles of the second order parts of the orders are delivered to a sorting device by means of the second transport system;
j) the articles of the second order parts of the orders are sorted in the sorting device according to the target article sequence;
k) the articles of the second order parts are removed from the sorting device and the articles of the second order parts of the orders are delivered to the second picking station according to the target article sequence by means of the second transport system;
l) the articles of the respective second order part of the orders are loaded onto the order loading aid assigned to the respective order at the second picking station;
wherein the control device triggers the first transport system and the first transport system transports the order loading aid according to the specified target order sequence in order to perform the delivery according to step g), and
wherein the control device calculates a starting time for the retrieval according to step g) before the articles of the second order parts of the orders are sorted according to the target article sequence, and triggers the transport system to initiate the retrieval according to step g).

2. The method according to claim 1, wherein the second order part is assigned to one second picking station of a plurality of second picking stations and this assignment is used as a specification for the first order part.

3. The method according to claim 1, wherein an order to provide the articles of the second order part is issued when step d) is completed.

4. The method according to claim 1, wherein the first subsystem of the storage and picking system is formed by or comprises an article storage and the articles of the first order part are provided in this article storage and retrieved from this article storage to order.

5. The method according to claim 1, wherein the second subsystem of the storage and picking system is formed by or comprises a production and the articles of the second order part are produced in this production to order.

6. The method according to claim 1, wherein after being retrieved from storage or production articles of the second order part are transported into a presorting stage of the sorting device and pre-sorted there and subsequently transported to a final sorting stage of the sorting device and sorted there before being transported to the second picking station.

7. The method according to claim 6, wherein a delivery of the order loading aid and the articles of the first order part to the second picking station is initiated when step d) is completed and the articles of the second order part are available in the presorting stage or when step d) is completed and the articles of the second order part are available in the final sorting stage.

8. The method according to claim 1, wherein the order loading aids are configured differently to a hanging bag.

9. The method according to claim 1, wherein a transportation of the articles of the second order part is performed by the second transport system in hanging bags.

10. The method according to claim 9, wherein each article of the second order part is transported in one hanging bag.

11. The method according to claim 6, wherein after being retrieved from storage or production the articles of the second order part are transported to a buffer of the storage and picking system arranged between the second subsystem and the presorting stage.

12. A storage and picking system for picking articles into order loading aids, comprising:
a first subsystem in which articles can be provided;
a second subsystem in which articles can be provided;
an order-processing computer;
i) for the acquisition of a plurality of orders and determination of the articles comprised by the respective order,
ii) for the determination of a first order part having a first part of the articles comprised by the respective order which are provided in the first subsystem of the storage and picking system for each order of the acquired orders,
iii) for the determination of a second order part having a second part of the articles comprised by the respective order which are provided in the second subsystem for each order of the acquired orders,
a first picking station for the loading of an order loading aid assigned to the respective order with the articles of the first order part of the orders;
a second picking station for the loading of the order loading aid assigned to the respective order with the articles of the second order part of the orders;
a temporary storage for buffering the order loading aids;
a first transport system for the transportation of the order loading aid from the first picking station to the temporary storage and for the retrieval of the order loading aid from the temporary storage and delivery of the order loading aid to a second picking station;
a control device for the definition of a target article sequence in which the articles of the second order parts of the orders are provided at the second picking station of the storage and picking system, wherein the target article sequence specifies a target order sequence in which the orders at the second picking station are processed;
a sorting device for sorting the articles of the second order parts of the orders according to the target article sequence; and
a second transport system for delivering the articles of the second order parts of the orders to the sorting device and for removing the articles of the second order parts from the sorting device and delivering the articles of the second order parts of the order to the second picking station according to the target article sequence,
wherein the control device is further configured to:
trigger the first transport system to transport the order loading aids according to the specified target order sequence, and
calculate a starting time for the retrieval of the order loading aids from the temporary storage before the articles of the second order parts of the orders are sorted according to the target article sequence, and to trigger the first transport system to initiate the retrieval of the order loading aids from the temporary storage at the start time.

13. The storage and picking system according to claim 12, characterized in that the first subsystem of the storage and picking system is formed by or comprises an article storage for the provision of the articles of the first order part, wherein articles provided in this article storage can be retrieved from this article storage to order.

14. The storage and picking system according to claim 12, wherein the second subsystem of the storage and picking system is formed by or comprises a production, wherein the production is configured to produce the articles of the second order part to order.

15. The storage and picking system according to claim 14, wherein the production is configured to produce books, shoes, or clothing articles.

16. The storage and picking system according to claim 12, wherein the first transport system comprises a conveying system that differs from an overhead conveyor system.

17. The storage and picking system according to claim 12, wherein the second transport system comprises an overhead conveyor system for the suspended transportation of hanging bags.

18. A storage and picking system for picking articles comprising:
a first subsystem in which articles can be provided;
a second subsystem in which articles can be provided;
an order-processing computer;
a first picking station for the loading of an order loading aid assigned to the respective order with the articles of the first order part of the orders;
a second picking station for the loading of the order loading aid assigned to the respective order with the articles of the second order part of the orders;
a temporary storage for buffering the order loading aids;
a first transport system for the transportation of the order loading aid from the first picking station to the temporary storage and for the retrieval of the order loading aid from the temporary storage and delivery of the order loading aid to a second picking station;
a control device for the definition of a target article sequence in which the articles of the second order parts of the orders are provided at the second picking station of the storage and picking system, wherein the target article sequence specifies a target order sequence in which the orders at the second picking station are processed;
a sorting device for sorting the articles of the second order parts of the orders according to the target article sequence; and
a second transport system for delivering the articles of the second order parts of the orders to the sorting device and for removing the articles of the second order parts from the sorting device and delivering the articles of the second order parts of the order to the second picking station according to the target article sequence.

19. The storage and picking system as claimed in claim 18, wherein the computer is configured for:
i) the acquisition of a plurality of orders and determination of the articles comprised by the respective order, and/or
ii) the determination of a first order part having a first part of the articles comprised by the respective order which are provided in the first subsystem of the storage and picking system for each order of the acquired orders, and/or
iii) for the determination of a second order part having a second part of the articles comprised by the respective order which are provided in the second subsystem for each order of the acquired orders.

20. The storage and picking system as claimed in claim 18, wherein the control device is configured to at least one of:
trigger the first transport system to transport the order loading aids according to the specified target order sequence, or
calculate a starting time for the retrieval of the order loading aids from the temporary storage before the articles of the second order parts of the orders are sorted according to the target article sequence, and to trigger the first transport system to initiate the retrieval of the order loading aids from the temporary storage at the start time.
